(19) United States
(12) Patent Application Publication
(10) Pub. No.: US 2012/0150764 A1
(43) Pub. Date: Jun. 14, 2012

(54) METHOD AND SYSTEM FOR AUTOMATED BUSINESS ANALYTICS MODELING

(76) Inventor: Payman Sadegh, Arlington, VA (US)

(21) Appl. No.: 13/316,195

(22) Filed: Dec. 9, 2011

Related U.S. Application Data
(60) Provisional application No. 61/421,695, filed on Dec. 10, 2010.

(51) Int. Cl. G06Q 10/06

(52) U.S. Cl. 705/348

(57) ABSTRACT

A software system provides a programming language for non-mathematical experts to define the business relations underlying the analytical problem combined with an interpretation engine, model build engine, and model simulation engine to process user information and produce the desired output. By integrating and streamlining model definition and data processing, operating directly at the level of business relations and attributes, the software of the present invention opens up the world of advanced analytics to non-mathematical experts.

### CROSS-REFERENCE TO RELATED APPLICATIONS

This application claims the benefit of priority of U.S. provisional patent application No. 61/421,695, filed Dec. 10, 2010, the contents of which are herein incorporated by reference.

### BACKGROUND OF THE INVENTION

The present invention relates to business analytics and, more particularly, to a method and system for automated business analytics modeling.

The area of analytics has seen rapid growth in the last few years. Increased computing power combined with availability of an expanding set of analytics tools and services has enabled companies to turn large amounts of data into actionable information that will allow better decision making.

Despite the availability of a relatively large number of analytical tools and services, the process of translating a given business problem to its mathematical formulation counterpart, which is a key requirement prior to development of any analytical solution, remains a highly specialized task that typically requires large numbers of expensive consulting hours. Add to this the complexity arising from the need to keep developed analytic models current to address changing business needs and parameters as well as the cross-disciplinary nature of this effort given that, in a majority of cases, business analysts have limited mathematical modeling experience while analytic modeling experts usually lack domain knowledge.

Particular domains of interest include business forecasting and predictive modeling, where developed models simulate/predict the impact of external scenarios or internal business decisions on the outcomes of interest. Examples of these applications include optimizing marketing mix (e.g., pricing, promotion, and distribution decisions), scenario based forecasting (e.g., how future scenarios about the economic climate will impact the business), trend analysis (e.g., what segments of the market for a set of product categories drive the growth), and product optimization (how different attributes of a product drive the sales and how should the product be reconfigured/optimized accordingly).

Despite the availability of a variety of advanced analytical software systems, the process of defining a business problem into its mathematical counterpart remains highly manual, labor extensive and costly.

As can be seen, there is a need for a system and method that may interact with end-users directly or used in internal processes to accelerate the analytic model development cycle.

### SUMMARY OF THE INVENTION

In one aspect of the present invention, a computer-readable medium storing instructions adapted to be executed by a processor to perform a business analytics method, said method comprises interfacing with an end user to collect business relations and data; storing data and the collected business relations in a database; declaring which inputs drive which outputs directly using logical expressions on attributes defined for each time series in the database; parsing the business relations to produce mathematical input-output structures for model development and simulation; using the mathematical input-output structures and historical time series data to train and build mathematical models; using the mathematical models together with simulation time series data to simulate a desired outcome over a horizon provided by the data collected from the end user; and presenting results of the simulation to the end user.

In another aspect of the present invention, a computer program comprising a computer readable medium having computer readable instructions for modeling business analytics, the computer readable instructions configured to parse and interprets user declarations; develop mathematical input-output model structures for given relations defined by user declarations; extract data using data entities, the data entities being data series each tagged by a unique identifier, their attributes and logical expressions given in each input-output influence relation defined by the user declarations; make and requisite pre-, intermediate- and post processing transformations via functional transformations supplied by the user; train models using combinations of multiple regression and time series models; simulate outcome for a horizon given in configuration data; and present results to the user.

In a further aspect of the present invention, a computer system for modeling business analytics comprises a first data entity having data entities tagged by a unique identifier; a second data entity having data attribution where each unique identifier is mapped to an attribute or attribute value; a third data entity having configuration data that sets a historical period from which models are built; a fourth data entity having optional user inputs for advanced users to set different parameters of the models to be developed; a first user declaration where a user inputs declarations and defines relations in a form of a logical expression or as an iteration; and a second user declaration where the user inputs declarations and defines a relation as a functional transformation.

These and other features, aspects and advantages of the present invention will become better understood with reference to the following drawings, description and claims.

### BRIEF DESCRIPTION OF THE DRAWINGS

FIG. 1 is a schematic block diagram showing the relationship between exemplary data entries and exemplary user declarations according to an embodiment of the present invention; and

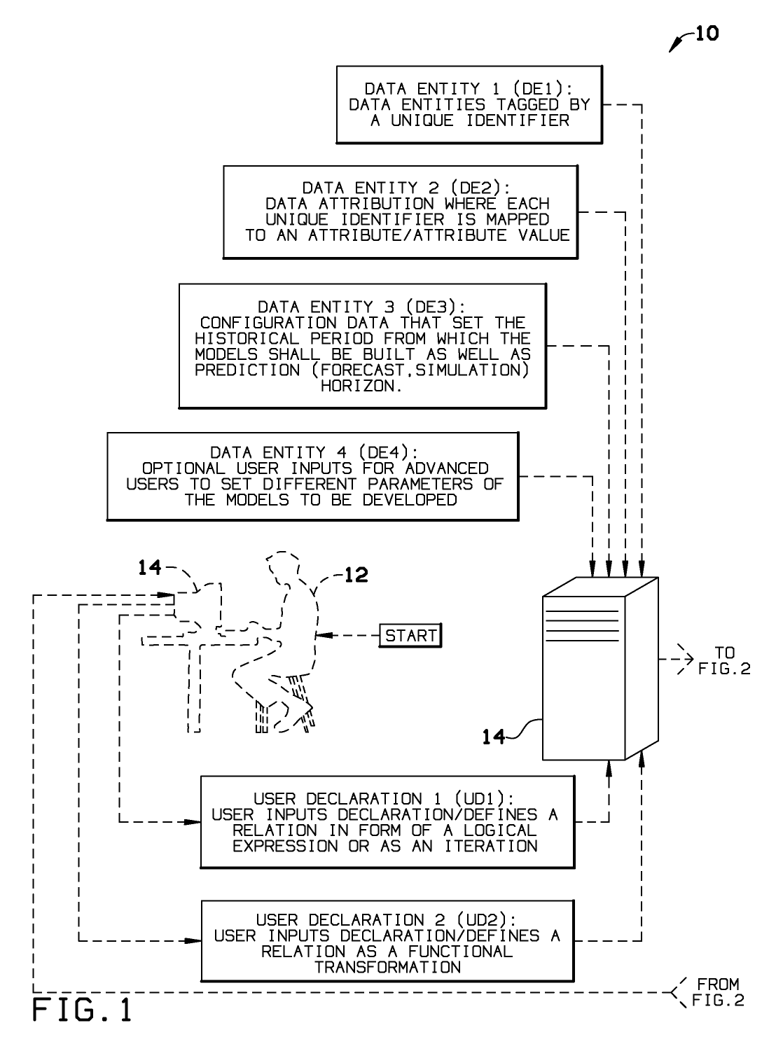

FIG. 2 is a schematic block diagram showing the steps utilized in an interpretation engine, according to an exemplary embodiment of the present invention.

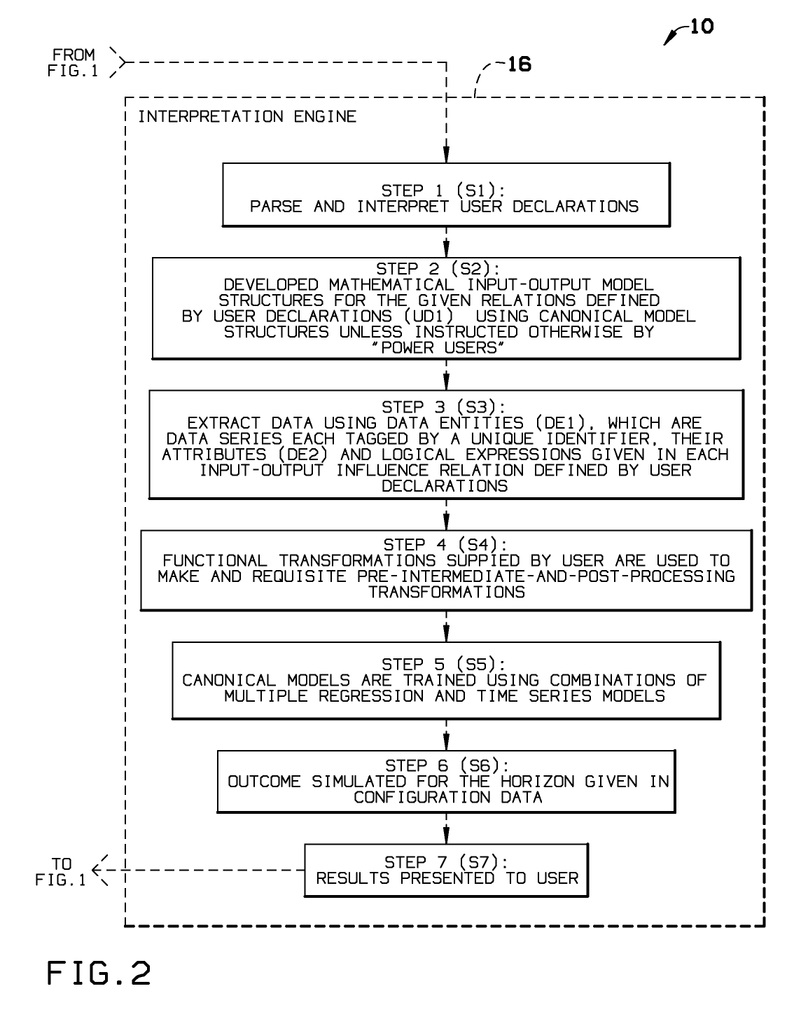

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a software system that provides a programming language for non-mathematical experts to define the business relations underlying the analytical problem combined with an interpretation engine, model build engine, and model simulation engine to process user information and produce the desired output. By integrating and streamlining model definition and data processing, operating directly at the level of business relations and attributes, the software of the present invention opens up the world of advanced analytics to non-mathematical experts.

The software and methods of the present invention accelerates the development cycle for analytical/predictive modeling by providing a language that allows the user to define (declare) the problem directly at the level of business relations between variables. An interpretation engine then processes user declarations to (1) identify the input-output structure of the models to be developed, (2) automatically query the required data sets to collect data for modeling and simulation, (3) perform mathematical transformations needed to build and fine tune (optimize) the underlying mathematical models, and (4) produce simulated outputs or predictions of the system behavior under user provided input scenarios or decisions (e.g., sales forecast of certain product categories, marketing mix simulation and optimization).

Embodiments of the present invention may have two main components—data elements and user declarations. The data elements may include a first data element (DE1) that includes data entities which are data series, each tagged by a unique identifier. For instance, the quarterly price—time series for red hot tomatoes over a period is a data series that must be tagged by a unique ID (e.g., PRICE_RH_TOM).

A second data element (DE2) may include data attribution where each unique identifier is mapped to an attribute/attribute value. For example, “PRICE_RH_TOM” may be assigned a “metric” attribute equal to “Price” and a “segment” attribute assigned to “Red Hot”. Furthermore, the attribution may have a hierarchical form. For example, PRICE_RH_TOM may be set to “inherit” from its category “Tomato”, resulting in transfer of all “Tomato” attributes to “PRICE_RH_TOM”, subject to rules that govern conflicts where multiple attributes can be assigned to a data entity.

A third data element (DE3) may include configuration data that set the historical period from which the models shall be built, as well as a prediction (forecast, simulation) horizon.

A fourth data element (DE4) may include optional user inputs for advanced users to set different parameters of the models to be developed.

The declarations are user descriptions of the business problem, expressed in a language that can be parsed and interpreted by the software. This language allows a number of user declarations.

For example, a first user declaration (UD1) may include input-output influence maps, referred to as relations. The relations may be defined directly in terms of the logical expressions on data attributes, where the expressions either select aggregates of the data that satisfy the logical expression, or iterate over individual data entities that satisfy the logical expression. In the aggregate form, for example, the user may declare that Tomato volume sales is influenced by unemployment and health awareness inputs. When building and simulating the models, the software may search for all data entities that satisfy “Volume” as the “metric” and “Tomato” as the “category” (obtained from DE2) to form the output data series for model development.

As instructed by the user, the under declaration (UD1) may calculate an aggregate (e.g., sum) of the selected data entities and relate the aggregate to the inputs. Alternatively, the user may choose to declare the relation as an Iteration, building one model per “data entity” that satisfies the aforementioned criteria using the declared inputs in each model. The language also allows importing the output of a relation as an input of another relation via user selected attribute matching. This will allow for example building as a model for all data entities that have “Price” as “metric” and “Tomato” as “category” and import the output as an input of another relation that iterates over all entities that have “Volume” as “metric” and “Tomato” as “category”, defining the matching criteria between the volumes and prices as, for example, “Product_Name”.

Other examples of user declarations that specify the business problem as relations between a given set of business variables include the following: (1) Variable attributes and their attribute values. For example, package size is an attribute of products. Product A has large package size (i.e. the value of the attribute “package size” is “large” for “product A”). (2) Influence of one variable on another. For example, sales of Product A is influenced by the economy, price of Product B is influenced by gas price, sales of product C is influenced by its advertisement spend and price. (3) A variable is a mix of several other variables. For example, total sales of Product A is the mix of the sales of the Product A over Channels C1, C2, and C3. (4) A variable attributes drive movements in that variable. For example, sales of Product A is influenced by the product category, sales of product B is influenced by its package size. (5) Relating movements in variables to some standard patterns known within the domain. For example, sales of product A follows “product introduction & growth” pattern, sales of product B follows the pattern of a “product in decline”. (6) Any combination of the above. For example, sales of product A is influenced by its advertisement spending, its price, and distribution outlet.

With respect to a second user declaration (UD2), while the relations are by default regarded as input-output maps to build statistical models from historical data, the user may define a given relation as a functional transformation, allowing a number or pre-, post- and intermediate processing functions on the data using well defined syntax. Additionally, while within the prediction/simulation horizon (see DE2, above), the output of the relations described in UD1 are normally computed from simulations performed on the developed models, the user may want to force the output of any relation to a set of desired values.

Examples of declarations within UD2 include the following: (1) Mapping each variable to a SQL query that provides the historical data for that variable. For example, Query Q1 provides the monthly sales of product A. (2) Specifying historical data for each variable by pointing to an area within a spreadsheet. For example, Columns A through L on Row 1 of Sheet1 provide historical monthly data for sales of product A. (3) Aggregating a set of variables to create new ones. For example, Sales of Crispy & Crunchy product segment is the sum of the sales of the Crispy segment and the sales of the Crunchy segment. And (4) any combination of the above.

Depending on the problem, the system may additionally allow the user to set several parameters commonly known within the domain of analysis. Examples include (1) Seasonality or cyclical behavior. For example, seasonality of product A is annual. (2) Delay or other time response parameters for the influence of one variable on another. For example, it takes a month for the spending dollars to show its impact on sales of product A and 6 months for the effect to disappear. And (3) Product growth and decline parameters. For example, product A follows “product introduction & growth” pattern for a period of 2 years. Alternatively, the system can find the optimal value of such parameters via best fit to the data (as described below) or set them to some default values.

The system automatically processes the above set of declarations and inputs to generate quantitative models that can be used to: (1) Forecast the variables over a time horizon. For example, forecast quarterly sales of product A over a two year horizon. (2) Simulate/predict variables response to change in attributes. For example, simulate how product A sales responds to changes in packaging size and type. (3) Simulate/predict variables response to other variables. For example, simulate/predict sales of product A under various future Economy and Energy Price scenarios. And (4) Any combination of the above.

Depending on the desired output, the system may allow the user to define a set of “plausibility criteria” for the produced output. Examples of such criteria are (1) Limit on variables. For example, Product A sales never to exceed 20M units. (2) Limit on variations in variable values. For example, Product A quarterly sales variations never to be outside ±10% range, Product A growth no more than 20% over 5 years. (3) Joint limits on the values or variations of the variables. For example, The sum of product A and B sales may not exceed $20M units. The sales growth of product A and product B may not exceed 20% over the next 5 years. And (4) Any combination of the above or other similar criteria.

Alternatively, soft bounds may be applied instead of hard limits to calculate a plausibility score for the calculated output instead of a binary plausibility indicator.

The plausibility criteria or score may be partly or completely computed via development of empirical distributions or other analysis of the historical data. For example, if sales of a product has never grown more than 5% a year in the last 5 years, a limit of 2×5%=10% may be placed on the forward looking growth rate.

By default the system would rely on a set of standard models to compute and optimize the parameters via one or a combination of the following: (1) Describing the magnitude of variable-variable or variable-attribute relations (log-linear, linear, or logistic input-output model, no interaction or first order attribute interaction, etc.); (2) Compute the residuals of the above models and re-process them using another set of standard models (e.g. linear time series) where the parameters of such models are also optimized using data; and (3) Other similar methods.

All internal parameters that impact the mathematical models but cannot be easily described or set by a business analyst could be optimized automatically using criteria based on the degree of model fit combined with other methods known in the empirical model development (such as Akaike Information Criterion or AIC) and/or plausibility criteria and scores defined by the user and/or computed from the historical data. A Bayesian approach may also be used to combine the plausibility scores with degree of fit to historical data.

Examples of the internal parameters that may be calculated by the modeling engine automatically are (1) The number of auto-regressive and moving average used terms in the time series models. (2) Forgetting factor used to allow better adaptation to time series changes by down-weighting older data points.

The following extensions may be conceived. Variable attributes assignments may be fuzzy. The degree of the fuzzy assignments (also known as membership degree in “Fuzzy Logic” terminology) may either be set by the user, optimized by the system, or a combination of both. For example, Product A belongs to the Food and the Snack categories with membership degrees 0.3 and 0.8 respectively.

The tool may offer power users an administrative module to allow one or a combination of (1) Exerting more control over internal model parameters; (2) Replacing the standard models with a set of advanced or custom-built models; (3) Choosing different algorithms for various computations; (4) Extend and/or customize the application to various domains of interest e.g. from generalized predictive modeling to customer lifetime value analysis and optimization; and (5) Other applicable controls.

A module may be provided to automate multiple runs of the quantitative model under various scenarios to optimize the related decisions using any number of optimal search algorithms that may be applicable. In such cases, the tool may additionally allow the user to define a set optimization goals. Examples are deciding on the best allocation of product outlet, product attributes, and pricing under various uncontrolled future scenarios such as the Economy or Energy Price.

Referring to the Figures, a system 10 according to an exemplary embodiment of the present invention may interface with an end user 12 to collect model descriptions (business relations) and data from the user. This interface 14 may be a simple text based editor, advanced graphical user interface, Application Programming Interface (API) or Web Service to upload the data. A database may be provided to store data and relations acquired via the inteface. The basic structure of the data in the database is as follows. Historical time series data for all the variables used as input or output, time series data over the simulation horizon (typically future horizon) for a subset of inputs. Each time series data used in any relation must be labeled by an attribute and attribute value. For example, Price of a product, say A, may be stored as a time series with the identifier PRICE_A. The identifier PRICE_PRODUCT_A may then be mapped to Metric-Price, Product-A Attribute-Attribute Values. The database also stores configuration data such as the historical period over which the model is built, simulation horizon, and the file from which business relations are read. Finally the database may include a file, say a text file that includes business relations provided by the user. The business relations declare which inputs drive which outputs directly using logical expressions on the attributes defined for each time series in the database, the output of another business relation, or a functional transformation of aforementioned variables.

The programming language provides a syntax for business relation definitions in the database from the file specified in the configuration data of the database. The business relations declare which inputs drive which outputs directly using logical expressions on the attributes defined for each time series in the database, the output of another business relation, or a functional transformation of the aforementioned variables.

The Syntax provides means of defining input-output relations between any combination of the following using logical expressions on time series attributes: single time series; aggregate of multiple time series using a properly defined aggregation function; individual time series within a set all selected by the same logical expression; the output of any other relation; and arbitrary functional transformations of any of the aforementioned single, aggregate, multiple, and output time series. The Syntax also provides means of disambiguation via user-defined identifiers when the output of one relation is defined as the input of another relation and the relations are defined over multiple time series. Finally, the Syntax may optionally define what output to print and in what format.

The (business) relations provided in the database may be parsed using the rules of the language in the Syntax to produce mathematical input-output structures for model development and simulation.

The mathematical input-output structures in the business relations, as well as historical time series data in the database, may be used to train and build mathematical models.

The mathematical models built and trained above, together with simulation time series data provided by the database, may be used to simulate the desired outcome over the horizon specified by the configuration data.

The results of the simulation generated by the mathematical models and/or the coefficients and parameters calculated as a result of training the model on historical data may then be presented to the end user.

The software automatically performs the following steps: (S1) Parse and interpret the user declarations. (S2) From the interpretation in (S1): develop mathematical input-output model structures for the given relations (see UD1) using canonical model structures unless instructed otherwise by “power users”. (S3) Extract data using the data entities (DE1), their attributes (DE2), and logical expressions given in each input-output influence relation (UD1) for each input-output model (see UD1). Both the input and output of the data belonging to the historical period (specified by DE3) may be used for training. Only the input data is used for simulation over the prediction/simulation horizon (specified by DE3). (S4) The functions specified in (UD2) are used to make any requisite pre-intermediate-and-post-processing transformations. (S5) Data extracted in (S4) are used to train the canonical models that are typically a combination of multiple regression and time series models. The user may either let the software optimize the structural parameters (e.g. order of the auto regressive or moving average terms) or directly specify it for any desired relation (UD1). In some instances of the invention, the “power user” may have the ability to specify a custom model structure altogether for a set of relations. (S6) Simulate the outcome for the horizon given in (DE3) using the model trained in (S5). (S7) Present the results to the user.

To make an exemplary embodiment of the present invention, a computer program may be developed that implements and integrates the various elements of the invention. The user interface can be developed using existing technology be it graphical user interface or existing text editors. The database and business relations can be implemented in existing database systems or in simplest case using text files or spreadsheet files. The programming language shall be first designed to the detailed specifications and shall be implemented using any of the existing programming languages from C to higher level languages such as MATLAB, Python, or R. Standard input-output mathematical relations can be used to build the mathematical structures. Examples of such standard model structures are linear regression, loglinear regression, or logistic regression combined with time series components such as ARMA model structures. The software may also allow power users to define and implement their own input-output model structures or provide an API or webservice to an already implemented model structure. Maximum likelihood, least squares, or similar estimation algorithms may be used to train the parameters/coefficients of the model using historical data. Simulation involves feeding simulation time series to the trained model as input and producing the output for every relation. For relations that use another relation output as input, the simulations shall flow in a cascaded manner. Presentation of the results can take advantage of existing technologies ranging from simple output on text file, spreadsheet file, or advanced graphical user interface.

A user has to prepare the database that will involve loading relevant time series data to the database, assigning to the time series data attributes-attribute values, and setting up the configuration data. The user shall also defined business relations that relate the inputs and outputs either using the programming language provided. A typical user will then run the software and view the results of the simulations. A power user may want to define more details about the mathematical model structures used instead of relying on standard default model structures. The user will then view the results of the simulation and if needed run the system multiple times, for example with various future values for the controllable inputs, to optimize the desired outcome. A user may use available historical data to simulate, predict, and forecast desired outcomes typically in a business setting (e.g. product sales) under various future or what-if scenarios and user decisions. This allows the user to optimize controlled decisions and identify risks and opportunities due to external (uncontrolled) factors. Simulation under various input scenarios also allows decomposition of the predicted outcome into contributions from various inputs.

The present invention may be used in any field where it is of interest to develop predictive or analytics models, the invention may find application. Although the domain of the invention is meant to be related to business modeling, the invention may be used in a variety of other applications. For instance the tool may be used to perform longitudinal and comparative studies in education or healthcare performance.

### EXAMPLE

The following Table shows analytical syntax for an exemplary demonstration of the system and software of the present invention.

```
Model M1 begin
--Model aggregate volume of vegetables as function of unemployment consumer
trend (health and wellness)
      Relation R1 begin
            Output: Category->Vegetable *Metric->Volume ;
            Input: Economy->Unemployment as Unemployment, ConsumerTrend-
        >HealthAndWellness as HealthAndWellness;
      Relation end
--Model price of each product within the vegetable category as function of
consumer price index (CPI)
      Relation R2 begin
            Output: Iterate over Category->Vegetable *Metric->Price id
        by ProductName;
            Input: Economy->CPI as CPI;
      Relation end
--Model volume of each product within the vegetable category as function of
unemployment,health and wellness, price (imported from R2), and total
volume category (imported from R1)
      Relation R3 begin
            Output: Iterate over Category->Vegetable *Metric->Volume id
      by ProductName;
            Input: Economy->Unemployment as unemployment, ConsumerTrend-
      >HealthAndWellness as HealthAndWellness,
            Import from R2 as price, Import from R1 as category;
      Relation end
--Calculate the dollar value of each product within vegetable category by
multiplyting price and volume imported from R2 and R3
      Relation R4 begin
            Output: Iterate over Category->Vegetable *Metric->Dollar id
      by ProductName;
            Input: Import from R2 as price, Import from R3 as volume;
      Relation end
Model end
M1 R4 is function begin
return(@volume *@price);
function end
Print begin
M1 R1;
M1 R2;
M1 R3;
M1 R4;
Print end
```

An exemplary attributes table for this example is shown below:

| Attr | Attr Value |
|---|---|
| Economy | Fuelprice |
| Economy | Unemployment |
| Consumertrend | Healthndwellness |
| Economy | CPI |
| Inherits.from | Tomato |
| Inherits.from | Tomato |
| Inherits.from | Lettuce |
| Inherits.from | Lettuce |
| Inherits.from | Cucumber |
| Inherits.from | Cucumber |
| Inherits.from | Mango |
| Inherits.from | Mango |
| Inherits.from | Reds |
| Color | Red |
| Color | Green |
| Category | Vegetable |
| Category | Vegetable |
| Segment | Red_vegetable |
| Segment | Green_vegetable |
| Color | DarkRed |
| ProductName | Tomato |
| Category | Vegetable |
| Segment | Red |
| ProductName | Lettuce |
| Category | Vegetable |
| Segment | Green |
| ProductName | Cucumber |
| Category | Vegetable |
| Segment | Green |
| Category | Fruit |

A data table for this example is shown below:

| ID | 2008-Q1 | 2008-Q2 | 2008-Q3 | 2008-Q4 | 2009-Q1 | 2009-Q2 | 2009-Q3 | 2009-Q4 |
|---|---|---|---|---|---|---|---|---|
| fuelprice | 1 | 1.5 | 2 | 2.5 | 3 | 3.5 | 4 | 5 |
| unemployment | 5 | 5 | 5 | 6 | 7 | 8 | 9 | 9 |
| healthandwellness | 1 | 1.5 | 2 | 2.5 | 3 | 3.5 | 4 | 4.5 |
| cpi | 1.25 | 1.25 | 1.25 | 1.5 | 1.75 | 2 | 2.25 | 2.25 |
| Tomato_Volume | 100 | 200 | 100 | 200 | 200 | 220 | 240 | 260 |
| Tomato_Price | 2 | 2.06 | 2.1218 | 2.18545 | 2.251018 | 2.318548 | 2.388105 | 2.459748 |
| Lettuce_Volume | 200 | 100 | 300 | 300 | 350 | 400 | 450 | 500 |
| Lettuce_Price | 4 | 5 | 6 | 5 | 6 | 7 | 4 | 5 |
| Cucumber_Volume | 400 | 100 | 200 | 100 | 150 | 200 | 100 | 150 |
| Cucumber_Price | 3 | 3.12 | 3.2448 | 3.37459 | 3.509576 | 3.649959 | 3.795957 | 3.947795 |
| Mango_Volume | 100 | 200 | 100 | 200 | 200 | 220 | 240 | 260 |
| Mango_Price | 2 | 2.06 | 2.1218 | 2.18545 | 2.251018 | 2.318548 | 2.388105 | 2.459748 |

| ID | 2010-Q1 | 2010-Q2 | 2010-Q3 | 2010-Q4 | 2011-Q1 | 2011-Q2 | 2011-Q3 | 2011-Q4 |
|---|---|---|---|---|---|---|---|---|
| fuelprice | 6 | 7 | 8 | 9 | 10 | 11 | 12 | 13 |
| unemployment | 9 | 9 | 9 | 9 | 9 | 9 | 8.5 | 8.5 |
| healthandwellness | 5 | 5.5 | 6 | 6.5 | 7 | 7.5 | 8 | 8.5 |
| cpi | 2.25 | 2.25 | 2.25 | 2.25 | 2.25 | 2.25 | 2.125 | 2.125 |
| Tomato_Volume | 280 | 300 | 320 | 340 | | | | |
| Tomato_Price | 2.53354 | 2.609546 | 2.687833 | 2.2768468 | | | | |
| Lettuce_Volume | 550 | 600 | 650 | 700 | | | | |
| Lettuce_Price | 6 | 7 | 8 | 9 | | | | |
| Cucumber_Volume | 200 | 100 | 200 | 100 | | | | |
| Cucumber_Price | 4.105707 | 4.269935 | 4.440733 | 4.618362 | | | | |
| Mango_Volume | 280 | 300 | 320 | 340 | | | | |
| Mango_Price | 2.53354 | 2.609546 | 2.687833 | 2.768468 | | | | |

The new language invented herewithin may be used to define relations between business variables directly on attribute of the data. The above attributes and date tables may belong to the database and syntax of the language as shown in the above language table. The interpreter for the language has been implemented and is used to solve real world problems in predictive modeling and forecasting. The above is merely a sample or the modeling that may be achieved from the present invention.

It should be understood, of course, that the foregoing relates to exemplary embodiments of the invention and that modifications may be made without departing from the spirit and scope of the invention as set forth in the following claims.

What is claimed is:

1. A computer-readable medium storing instructions adapted to be executed by a processor to perform a business analytics method, said method comprising:
interfacing with an end user to collect business relations and data;
storing data and the collected business relations in a database;
declaring which inputs drive which outputs directly using logical expressions on attributes defined for each time series in the database;
parsing the business relations to produce mathematical input-output structures for model development and simulation;
using the mathematical input-output structures and historical time series data to train and build mathematical models;
using the mathematical models together with simulation time series data to simulate a desired outcome over a horizon provided by the data collected from the end user; and
presenting results of the simulation to the end user.

2. The computer-readable medium of claim 1, wherein the interfacing is achieved through at least one of a simple text based editor, an advanced graphical user interface, an application programming interface, and a web service to upload the data.

3. The computer-readable medium of claim 1, wherein the data includes historical time series data from all variables used as input or output, and time series data over a simulation horizon.

4. The computer-readable medium of claim 1, wherein the method further comprises using a programming language to provide a syntax for definitions of the business relations.

5. A computer program comprising: a computer readable medium having computer readable instructions for modeling business analytics, the computer readable instructions configured to:
parse and interprets user declarations;
develop mathematical input-output model structures for given relations defined by user declarations;
extract data using data entities, the data entities being data series each tagged by a unique identifier, their attributes and logical expressions given in each input-output influence relation defined by the user declarations;
make and requisite pre-, intermediate- and post processing transformations via functional transformations supplied by the user;
train models using combinations of multiple regression and time series models;
simulate outcome for a horizon given in configuration data; and
present results to the user.

6. The computer program of claim 5, wherein the mathematical input-output structures are developed by canonical model structures.

7. The computer program of claim 5, wherein the mathematic input-output structures are developed by power users.

8. The computer program of claim 5, wherein the user declarations are entered through at least one of a simple text based editor, an advanced graphical user interface, an application programming interface, and a web service to upload the data.

9. A computer system for modeling business analytics, the system comprising:
a first data entity having data entities tagged by a unique identifier;
a second data entity having data attribution where each unique identifier is mapped to an attribute or attribute value;
a third data entity having configuration data that sets a historical period from which models are built;
a fourth data entity having optional user inputs for advanced users to set different parameters of the models to be developed;
a first user declaration where a user inputs declarations and defines relations in a form of a logical expression or as an iteration; and
a second user declaration where the user inputs declarations and defines a relation as a functional transformation.
